(19) United States
(12) Patent Application Publication
(10) Pub. No.: US 2026/0230952 A1
(43) Pub. Date: Aug. 6, 2026

(54) NETWORK MANAGEMENT

(71) Applicant: Nokia Technologies Oy, Espoo (FI)

(72) Inventors: Arled PAPA, Munich (DE); Bernhard WEGMANN, Munich (DE); György Tamás WOLFNER, Budapest (HU); Irina-Mihaela BALAN, Munich (DE); Halit Murat GÜRSU, Munich (DE); Ahmad AWADA, Munich (DE); Krzysztof KORDYBACH, Wroclaw (PL)

(21) Appl. No.: 19/151,766

(22) PCT Filed: Feb. 16, 2023
(86) PCT No.: PCT/EP2023/053941

§ 371 Date: Jul. 29, 2025

(51) Int. Cl. H04W 36/00; H04W 74/0833; H04W 76/20

(52) U.S. Cl. CPC H04W 36/0069; H04W 74/0833; H04W 76/20

(57) ABSTRACT

According to an example aspect of the present invention, there is provided an apparatus configured to be configured with dual connectivity wherein a first radio link is maintained from the apparatus to a master node, and simultaneously a second radio link is maintained from the apparatus to a cell of a secondary node, participate in a reconfiguration of the configured dual connectivity wherein the cell of the secondary node is replaced in the configured dual connectivity with a new cell, generate a cell change report which comprises reconfiguration information, and indicate to the master node, responsive to successfully connecting with the new cell, that the cell change report is available in the apparatus.

### FIELD

The present disclosure relates to messaging in dual connectivity scenarios in communication networks.

### BACKGROUND

Cellular communication networks comprise radio-access networks, RANs, which comprise base stations. A network may comprise hundreds or even thousands of base stations, and each base station may control one or more cells of the cellular communication network.

A dual connectivity is a situation where a user equipment, UE, of the cellular communication network has two simultaneous radio links, one to a master node MN and another to a secondary node SN.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core and at least one memory storing instructions that, when executed by the at least one processing core, cause the apparatus at least to be configured with dual connectivity wherein a first radio link is maintained from the apparatus to a master node, and simultaneously a second radio link is maintained from the apparatus to a cell of a secondary node, participate in a reconfiguration of the configured dual connectivity wherein the cell of the secondary node is replaced in the configured dual connectivity with a new cell, generate a cell change report which comprises reconfiguration information, and indicate to the master node, responsive to successfully connecting with the new cell, that the cell change report is available in the apparatus.

According to a second aspect of the present disclosure, there is provided an apparatus comprising at least one processing core and at least one memory storing instructions that, when executed by the at least one processing core, cause the apparatus at least to communicate as a master node in a configured dual connectivity with a user equipment wherein a first radio link is maintained from the apparatus to the user equipment, and simultaneously the apparatus controls a secondary node to maintain a second radio link with the user equipment, participate in a reconfiguration of the configured dual connectivity wherein a cell of the secondary node is replaced in the configured dual connectivity with a new cell, and receive, after receiving from the user equipment a radio resource control reconfiguration complete message and comprised in the reconfiguration of the dual connectivity, from the user equipment an indication that a cell change report is available in the user equipment.

According to a third aspect of the present disclosure, there is provided a method comprising an apparatus being configured with dual connectivity wherein a first radio link is maintained from the apparatus to a master node, and simultaneously a second radio link is maintained from the apparatus to a cell of a secondary node, participating in a reconfiguration of the configured dual connectivity wherein the cell of the secondary node is replaced in the configured dual connectivity with a new cell, and generating a cell change report which comprises information on the reconfiguration, and indicating, responsive to successfully connecting with the new cell, to the master node that the cell change report is available in the apparatus.

According to a fourth aspect of the present disclosure, there is provided a method comprising communicating as a master node in a configured dual connectivity with a user equipment wherein a first radio link is maintained from the apparatus to the user equipment, and simultaneously the apparatus controls a secondary node to maintain a second radio link with the user equipment, participating in a reconfiguration of the configured dual connectivity wherein cell of a the secondary node is replaced in the configured dual connectivity with a new cell, and receiving, after receiving from the user equipment a radio resource control reconfiguration complete message and comprised in the reconfiguration of the dual connectivity, from the user equipment an indication that a cell change report is available in the user equipment.

According to a fifth aspect of the present disclosure, there is provided an apparatus comprising means for being configured with dual connectivity wherein a first radio link is maintained from the apparatus to a master node, and simultaneously a second radio link is maintained from the apparatus to a cell of a secondary node, participating in a reconfiguration of the configured dual connectivity wherein the cell of the secondary node is replaced in the configured dual connectivity with a new cell, and generating a cell change report which comprises information on the reconfiguration, and indicating, responsive to successfully connecting with the new cell, to the master node that the cell change report is available in the apparatus.

According to a sixth aspect of the present disclosure, there is provided an apparatus comprising means for communicating as a master node in a configured dual connectivity with a user equipment wherein a first radio link is maintained from the apparatus to the user equipment, and simultaneously the apparatus controls a secondary node to maintain a second radio link with the user equipment, participating in a reconfiguration of the configured dual connectivity wherein cell of a the secondary node is replaced in the configured dual connectivity with a new cell, and receiving, after receiving from the user equipment a radio resource control reconfiguration complete message and comprised in the reconfiguration of the dual connectivity, from the user equipment an indication that a cell change report is available in the user equipment.

According to a seventh aspect of the present disclosure, there is provided a non-transitory computer readable medium having stored thereon a set of computer readable instructions that, when executed by at least one processor, cause an apparatus to at least be configured with dual connectivity wherein a first radio link is maintained from the apparatus to a master node, and simultaneously a second radio link is maintained from the apparatus to a cell of a secondary node, participate in a reconfiguration of the configured dual connectivity wherein the cell of the secondary node is replaced in the configured dual connectivity with a new secondary node, and generate a cell change report which comprises information on the reconfiguration, and indicate, responsive to successfully connecting with the new cell, to the master node that the cell change report is available in the apparatus.

According to an eighth aspect of the present disclosure, there is provided a non-transitory computer readable medium having stored thereon a set of computer readable instructions that, when executed by at least one processor, cause an apparatus to at least communicate as a master node in a configured dual connectivity with a user equipment wherein a first radio link is maintained from the apparatus to the user equipment, and simultaneously the apparatus controls a secondary node to maintain a second radio link with the user equipment, participate in a reconfiguration of the configured dual connectivity wherein cell of a the secondary node is replaced in the configured dual connectivity with a new cell, and receive, after receiving from the user equipment a radio resource control reconfiguration complete message and comprised in the reconfiguration of the dual connectivity, from the user equipment an indication that a cell change report is available in the user equipment.

### BRIEF DESCRIPTION OF THE DRAWINGS

FIG. 1 illustrates an example system in accordance with at least some embodiments of the present invention;

FIG. 2A illustrates an example dual connectivity reconfiguration process;

FIG. 2B illustrates an example secondary cell change report;

FIG. 3 illustrates an example apparatus capable of supporting at least some embodiments of the present invention;

FIG. 4 illustrates signalling in accordance with at least some embodiments of the present invention, and

FIG. 5 is a flow graph of a method in accordance with at least some embodiments of the present invention.

### EMBODIMENTS

In dual connectivity situations, a change in the secondary node, SN, may take place at the initiative of the master node, MN, which is referred to as a MN-initiated secondary node change, or the secondary node, SN, which is referred to as a SN-initiated secondary node change. In order to provide the network with information concerning coverage and real-life fading characteristics in cells, for example, UEs may be configured to provide secondary cell change reports to the network after the secondary node change. As will be disclosed herein, an enhanced mechanism to provide these secondary cell change reports to the network is provided which improves promptness and dependability of secondary cell change report delivery. This provides the overall beneficial effect that the network is better informed of its coverage characteristics, which enables it to self-optimize and plan future cell changes more effectively.

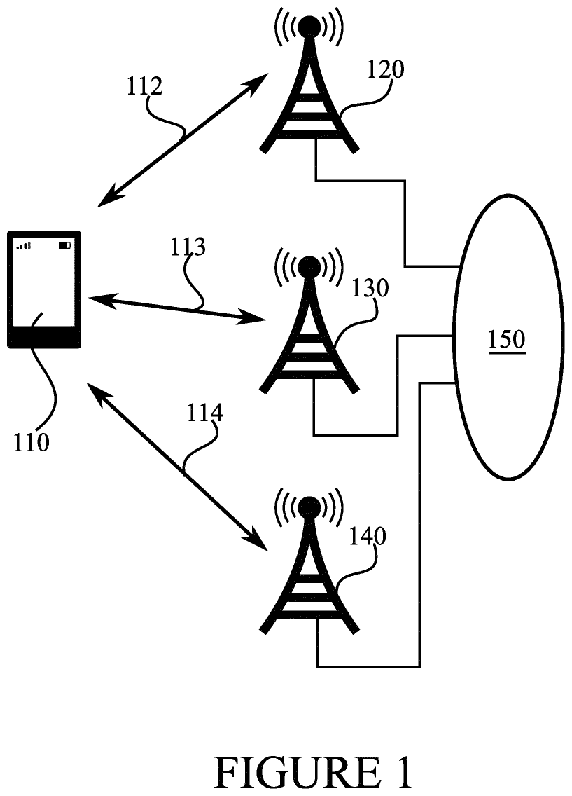

FIG. 1 illustrates an example system in accordance with at least some embodiments of the present invention. The system of FIG. 1 comprises a user equipment, UE 110. UE 110 may be a smartphone, feature phone, tablet computer, laptop computer, Internet of Things, IoT, node, a wireless local area network, WLAN, access point with cellular connectivity or a connected car connectivity module, for example.

The illustrated system further comprises base station 120 and base station 130. UE 110 is in dual connectivity with base stations 120, 130, such that base station 120 acts as a master node in the dual connectivity and base station 130 acts as a secondary node in the dual connectivity. The master node MN has more control over the configured dual connectivity, while UE 110 is provided a configuration identifying the roles of the respective base stations, to configure UE 110 to successfully participate in the dual connectivity. The master node MN provides a control plane connection to the core network. Base stations 120, 130 may be configured to operate based on a same radio-access technology, RAT, or based on different RATs. For example, base station 120 may operate based on 5G, also known as New Radio, technology while base station 130 may be configured based on 4G, also known as Long Term Evolution, technology. Alternatively, both base stations 120, 130, may be configured based on a same RAT, such as 5G, for example. Further RATs which may be applicable include wireless code division multiple access, WCDMA, and the CDMA2000 technology.

The base stations are connected with one or more core networks 150. Core networks comprise nodes which perform tasks which affect the network as a whole. Examples of such tasks include maintenance of subscriber lists, providing gateways to further networks, controlling RAN nodes and enforcing configured network policies. 4G and 5G base stations may be connected with a same core network, or to different core networks, depending on the network architecture.

At least some of the base stations may be connected to each other via an inter-base station interface, of which X2 and Xn interfaces are examples. In case two base stations are not connected via an inter-base station interface, they may communicate with each other via the core network, or core networks via the NG interface as an example. To maintain clarity of the illustration, inter-base station interfaces are not included in FIG. 1.

Radio link 112 connects UE 110 with base station 120, and radio link 113 connects UE 110 simultaneously with base station 130. As the base stations may use differing RATs, also radio links 112, 113 may be based on different RATs, to enable interoperation of UE 110 with both base stations 120, 130. The radio links are bidirectional, where an uplink direction conveys information from the UE to the base station, and a downlink direction conveys information from the base station to the UE.

In a dual connectivity session, a UE in a connected state, such as a RRC connected state, is configured to utilize radio resources provided by two distinct schedulers, located in two distinct base stations. The two distinct base stations, may be connected via a backhaul connection, such as an inter-base station interface, such as an X2 or Xn interface, for example. In a multi-radio access technology, RAT, in a dual connectivity session the two nodes may be configured based on different radio access technologies, for example, one of the two nodes may be configured based on 5G technology, and the other based on 4G technology, which is also known as long term evolution, LTE.

Overall, a dual connectivity may be initiated to provide UE 110 with additional bandwidth to transfer data via the secondary node, or a connection fulfilling a quality of service criterion not available through the master node, for example. Furthermore, dual connectivity may be used by the master node MN to offload some of its traffic to the secondary node SN for load balancing purposes.

It may occur, that during dual connectivity it makes sense based on measurements provided by the UE, to change the secondary node while keeping the master node unchanged. In other words, the dual connectivity is reconfigured by changing the secondary node or a cell within the secondary node. For example, UE 110 may move toward an edge of a coverage area of a cell controlled by the secondary node and used by UE 110 in the dual connectivity to connect with the secondary node. As another example, the original secondary node may become highly loaded, or face shutdown for software updating. Yet further, the UE may need a connection type not supported by the original secondary node, but supported by another node suitable for use as the secondary node and accessible by UE 110. The secondary node controls a secondary cell group, SCG, wherein a primary secondary cell, PSCell is a primary cell of the SCG. The SCG may comprise other cells in addition to the PSCell.

To implement the change of the secondary node, the master node may signal to the new secondary node, which is base station 140 in FIG. 1, to request its addition to the dual connectivity, and likewise the master node may signal to the original secondary node, base station 130 in FIG. 1, to release it from the dual connectivity. As noted above, in other cases, the secondary node initiates the change in secondary node. The master node may also instruct UE 110 to participate in the reconfiguration of the dual connectivity by establishing a radio link with the new secondary node.

UE 110 will release radio link 113 with base station 130 and establish radio link 114 with base station 140, which will be the new secondary node following the dual connectivity reconfiguration process. In terms of radio link processing, the reconfiguration resembles a handover from base station 130 to base station 140.

Cellular networks may be configured to collect successful handover reports from UEs. A successful handover report may comprise information useful for performing self-organizing network behaviour in the cellular network, which may include tasks such as, for example, coverage and capacity optimization, inter-system and inter-RAT energy saving, inter-system load balancing, 2-step random access channel, RACH, optimization, and mobility enhancement optimization. Although a handover may be successful, momentary outages may nonetheless occur during the handover, and successful handover reports provide the network information it may use in optimizing future handover to reduce the effects of such outages. For example, an outage may result in case a UE is successful in performing a random access process with the target node, but not at the first attempt.

A UE may be requested to compile a successful handover report in a handover command message, and the handover target node, such as the target base station, may fetch the successful handover report after the handover is complete. In detail, the UE may indicate in a radio resource control, RRC, reconfiguration complete message it sends to the target node after successfully establishing a radio link with the target node, that it has a successful handover report, and the target node may responsively request the UE to send the successful handover report to the target node.

In a dual connectivity reconfiguration where the secondary node or a cell in the secondary node is changed, a successful handover report may be referred to as a secondary cell change report, wherein it performs a similar purpose in the network as a successful handover report. The secondary cell change report may be a successful PSCell change report, SPR, for example. The secondary cell change report may be referred to as a cell change report for brevity.

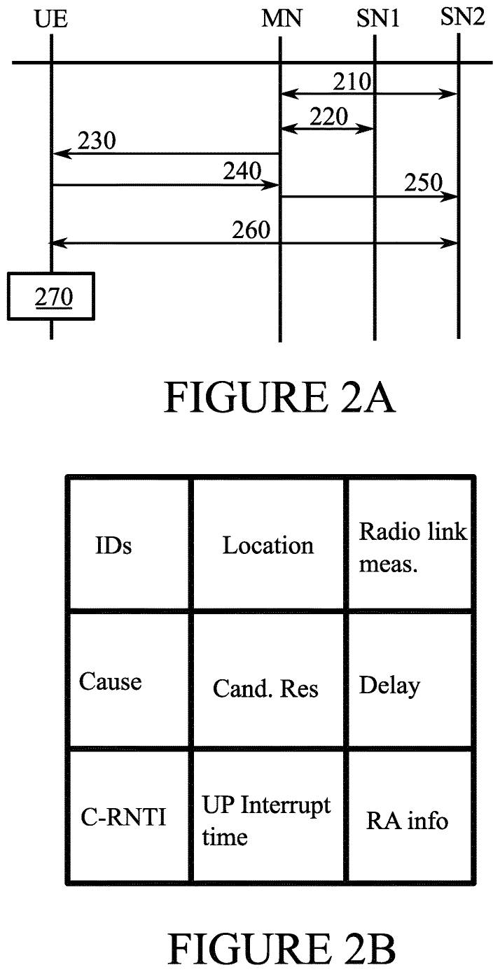

FIG. 2A illustrates an example dual connectivity reconfiguration process. In the beginning, the UE is in a dual connectivity with master node MN and SN1 as the secondary node. Initially the master node, MN, sends an addition request to the new secondary node SN2 and receives in return an addition request acknowledge, where the new secondary node SN2 agrees to be added to the dual connectivity, phase 210. The master node then issues a release request to the original secondary node SN1, and receives in return a release request acknowledge, indicating the original secondary node has understood it will be removed from the dual connectivity, phase 220. The master node will then, in this example, send an RRC re-configuration message to the UE, phase 230, which instructs the UE to seek a connection to new secondary node SN2, and further, to compile a secondary cell change report concerning the reconfiguration of the dual connectivity. The compiling of the secondary cell change report may be subject to a condition, for example a condition based on a timer, or to plural conditions, such as conditions based on plural timers. Examples of suitable timers include, among others, a timer measuring a duration of the reconfiguration, a timer measuring a duration of outage during the reconfiguration and a timer measuring a duration of radio link establishment with the new secondary node SN2.

In phase 240, the UE indicates that the RRC reconfiguration is complete, and that no secondary cell change report is present in the UE, as the radio link to the new secondary node has not yet, when phase 240 takes place, been established and the UE needs information from the establishment of the radio link to complete the secondary cell change report generation. For example, the overall duration of the secondary node change is not yet known, since the secondary node change is not yet complete. The master node MN, in phase 250, informs the new secondary node SN2 that the UE is re-configured, after which the UE and the new secondary node SN2 perform a random access process, phase 260, which results in the radio link between UE and SN2 to be established. The secondary cell change report may then be compiled by the UE, phase 270, since it now has the information needed to generate it, however as the UE has already sent the RRC reconfiguration complete message to the master node in phase 240 and the secondary cell change is complete, the UE has no way to indicate to the network, as part of the secondary cell change procedure, that the secondary cell change report is available.

This results in the unfavourable situation, where the secondary cell change report compiled by the UE is not reported to the network, and may in fact be overwritten by a later secondary cell change report before it is reported to the network, the later secondary cell change report being compiled in connection with a further reconfiguration of the dual connectivity.

FIG. 2B illustrates an example secondary cell change report. The order in which information is included in the secondary cell change report is immaterial and the information elements may be in the report in any order. The example secondary cell change report comprises IDs, such as source and target cell identifiers. These would be identifiers of the cells controlled by the secondary node and new secondary node, respectively, involved in the dual connectivity reconfiguration and radio link release and establishment. Further, location information may comprise at least one indication of where the UE was when an outage occurred during the dual connectivity reconfiguration, for example. Radio link measurements may comprise measurements of some, or all, measurement IDs available at the time secondary cell change was accomplished, for example for all handover types. In this context, all handover types may include also conditional handovers.

A cause indicates which trigger caused the compilation of the secondary cell change report. For example, the cause may identify which timer condition, from among plural possible timer conditions, was the one which the UE responded to by compiling the secondary cell change report. Candidate results (Cand. Res in the figure) may indicate radio measurement results of candidate target cells in case of conditional secondary node change. Delay may indicate a length of time which has elapsed between conditional secondary node change execution toward a target cell and a corresponding latest configuration received for the selected target cell.

C-RNTI may indicate a cell radio network temporary identifier of the target cell, controlled by the new secondary node. A user plane, UP, interruption time may indicate a length of time the user plane was interrupted during the secondary node change. Finally, RA information may comprise information concerning random access, for example an indication if a random access-related timer is above a preconfigured threshold.

A secondary cell change report may comprise all the information illustrated in FIG. 2B, or only some and not all of the information or additional information. For example, a secondary cell change report may comprise the IDs, the Location and Radio-link measurements, or the IDs, the Location, Radio-link measurements and the Cause. In some cases the secondary cell change report may comprise the IDs and Location information. In yet further example cases the secondary cell change report may comprise the IDs, the Location and the Delay information elements.

Based on methods disclosed herein, the UE is enabled to report to the network availability of a secondary cell change report once the reconfiguration of the dual connectivity is complete. This may take place in a separate message, or by including in a message which is unrelated to the secondary node change and one the UE would anyhow send, an information element informing the network, such as the master node, of the presence of the secondary cell change report in the UE. An indication indicates the availability of the secondary cell change report from the UE towards the network that is transmitted by the UE after the UE has sent a message to the master node indicating the execution of the secondary node change configuration, and performed the random access procedure to the new SN. An example message that may be used by the UE to transmit the availability of the secondary cell change report is a UE assistance information message.

The UE may provide the indication of the availability of the secondary cell change report responsive to successfully connecting with the new secondary node. This may comprise providing the indication responsive to completing a random access process with the new secondary node, for example. Providing the indication responsive to successfully connecting with the new secondary node may comprise, for example, providing the indication within 1 second, within 3 seconds, within 5 seconds or within 10 seconds from completing the establishment of the radio link with the new secondary node. The radio link with the new secondary node may be considered established once the random access process with the new secondary node has been completed, for example. Further, or alternatively, providing the indication responsive to successfully connecting with the new secondary node may comprise that provision of the indication is comprised in the dual connectivity reconfiguration process which changes the secondary node to the new secondary node.

Whereas the reconfiguration of the dual connectivity is herein primarily described in terms of a master node-initiated change of the secondary node, it is also possible that the secondary node takes the initiative to change the secondary node in the reconfiguration of the dual connectivity. It is further possible that the secondary node is not changed in the reconfiguration, but the PSCell is changed to another cell within the secondary node, which is also provided by the original secondary cell. Thus, a common feature is that a cell controlled by the secondary node is changed in the reconfiguration of the dual connectivity, and a secondary cell change report is compiled by the UE of this reconfiguration. The new PSCell may be controlled by the same secondary node, or by a new secondary node. Radio link 113 in FIG. 1 connects the UE to the original PSCell, controlled by the original secondary node.

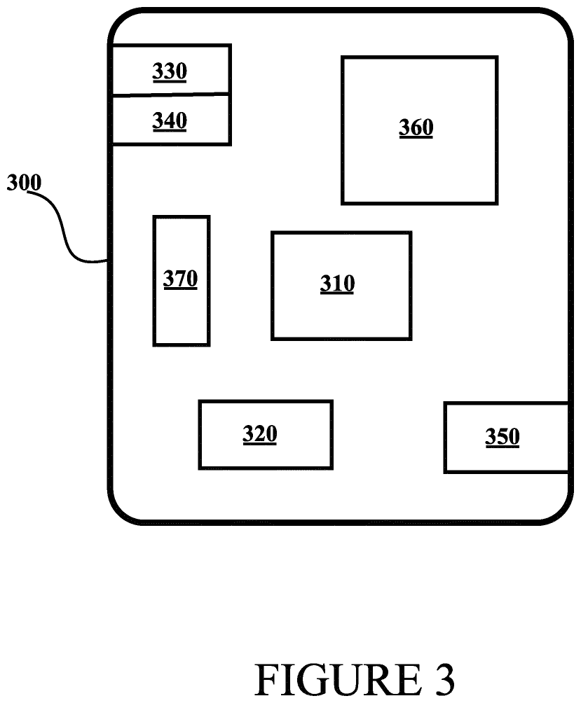

FIG. 3 illustrates an example apparatus capable of supporting at least some embodiments of the present invention. Illustrated is device 300, which may comprise, for example, a UE 110 or, in applicable parts, base station 120 of FIG. 1. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. When processor 310 comprises more than one processor, device 300 may be a distributed device wherein processing of tasks takes place in more than one physical unit. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300 such as being configured, participating, communicating and/or indicating. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a UE or base station, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300. Memory 320 may be non-transitory. The term “non-transitory”, as used herein, is a limitation of the medium itself (that is, tangible, not a signal) as opposed to a limitation on data storage persistency (for example, RAM vs. ROM).

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

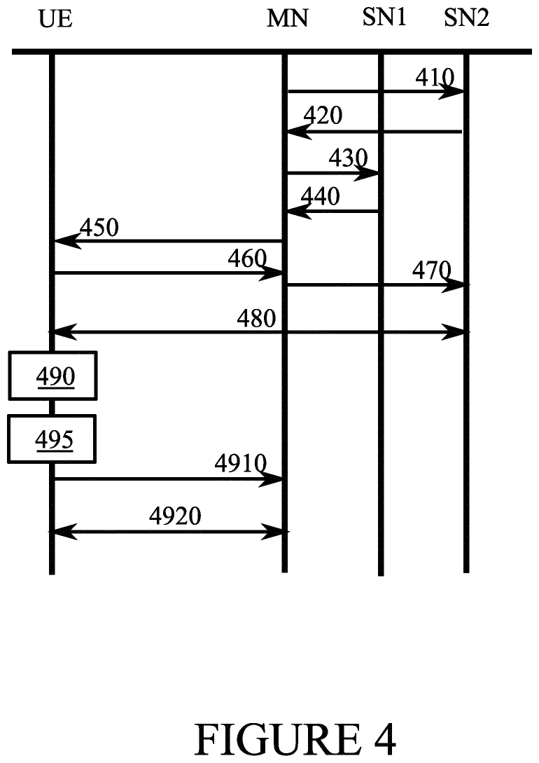

FIG. 4 illustrates signalling in accordance with at least some embodiments of the present invention. On the vertical axes are disposed, from the left, a UE, master node MN and secondary nodes SN1, SN2. Time advances from the top toward the bottom. Initially, the UE is in dual connectivity with MN as the master node and SN1 as the secondary node. The MN and SN1 may operate based on the same RAT, or based on different RATs, as described herein above.

In phase 410, the MN signals to the new secondary node SN2 to request addition of SN2 to the dual connectivity as a new secondary node, and in phase 420 node SN2 acknowledges this, accepting the addition of itself to the dual connectivity.

In phase 430, the MN signals to secondary node SN1, requesting its release from the dual connectivity, and in phase 440 secondary node SN1 responds, accepting its removal.

Further, in phase 450 MN signals to the UE, for example by transmitting a RRC reconfiguration message, informing the UE of new secondary node SN2. This phase may also comprise an instruction to the UE to compile a secondary cell change report concerning the reconfiguration of the dual connectivity wherein the secondary node is changed from SN1 to SN2. This phase may also include the MN instructing the UE concerning which message the UE should use to report the availability of the secondary cell change report. The instruction to compile the secondary cell change report may be subject to a condition, such as a timer-based condition, for example. An example of a timer-based condition is a condition based on a T304 timer, which is a timer which starts at the receiption of an RRC reconfiguration message, and stops at the successful establishment of a radio link to the new secondary node. Other examples of suitable timers are a T310 timer, which starts when the UE detects a physical-layer problem and stops when the UE receives a preconfigured number of synchronized signals, and a T312 timer, which starts when a measurement report is triggered, and stops when a preconfigured number of synchronized signals are received in the UE.

Phase 450 may further include an instruction for the UE to report the presence of a secondary cell change report in the UE as part of the dual connectivity reconfiguration process, for example responsive to successfully connecting to the new secondary cell. This instruction may be present in the message of phase 450 whether or not the request to compile the secondary cell change report is subject to a condition, or plural conditions.

In phase 460 the UE provides to the MN an indication that it has acted on the reconfiguration instruction of phase 450. This enables the MN to signal, in phase 470, to the new secondary node SN2, that the UE is reconfigured. Subsequently, in phase 480, the UE and new secondary node SN2 carry out a random access process with each other to establish a radio link between the UE and new secondary node SN2.

Following the random access process of phase 480, the UE generates, phase 490, the secondary cell change report, either responsive to the completion of the random access process of phase 480, and/or responsive to one or mode condition(s) provided by the MN in phase 450 being fulfilled. An example secondary cell change report is illustrated in FIG. 2B. The secondary cell change report may be a successful PSCell change report, SPR, for example.

In phase 495, the UE includes an indication of the availability of the secondary cell change report generated in phase 490 in a message to be transmitted to the MN. An example of such a message is a UE assistance information message, which comprises an RRC message the UE may use to inform the network of internal states of the UE. The message into which the indication has been included is transmitted from the UE in phase 4910, whereby the MN is informed of the presence of the secondary cell change report in the UE. In at least some embodiments, the message into which the indication is included is different from a RRC reconfiguration complete message. The MN requests and responsively receives the secondary cell change report in phase 4920, in other words the MN fetches the secondary cell change report from the UE.

The transmission of phase 4910 may take place responsive to the UE successfully connecting with the new secondary node SN2. This may mean the transmission of phase 4910 taking place responsive to successfully completing the random access process 480 with new secondary node SN2. In some embodiments, the transmission of phase 4910 takes place responsive to both a condition set by the master node, communicated to the UE in phase 450, being fulfilled and the UE successfully connecting to the new secondary node. Providing the indication responsive to successfully connecting with the new secondary node may comprise, for example, providing the indication within 1 second, within 3 seconds, within 5 seconds or within 10 seconds from completing the establishment of the radio link with the new secondary node.

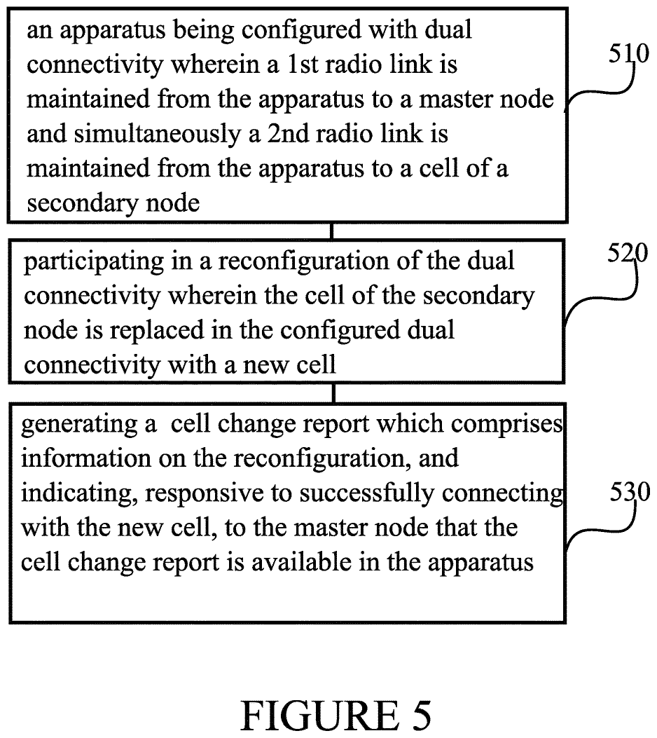

FIG. 5 is a flow graph of a method in accordance with at least some embodiments of the present invention. The phases of the illustrated method may be performed in UE 110, or in a control device configured to control the functioning thereof, when installed therein.

Phase 510 comprises an apparatus being configured with dual connectivity wherein a first radio link is maintained from the apparatus to a master node MN, and simultaneously a second radio link is maintained from the apparatus to a cell of a secondary node SN. Phase 520 comprises participating in a reconfiguration of the configured dual connectivity wherein the cell of the secondary node is replaced in the configured dual connectivity with a new cell, and finally, phase 530 comprises generating a cell change report which comprises information on the reconfiguration, and indicating, responsive to successfully connecting with the new cell, to the master node that the cell change report is available in the apparatus. The cell change report may be a secondary cell change report. Being configured with dual connectivity may comprise acting in a dual connectivity based on a stored dual connectivity configuration.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in managing communication networks.

### ACRONYMS LIST

4G fourth generation
5G fifth generation
MN master node
LTE long term evolution
PSCell primary secondary cell
RRC radio resource control
SN secondary node
WCDMA wideband code division multiple access

REFERENCE SIGNS LIST

| | |
|---|---|
| 110 | user equipment, UE |
| 120, 130, 140 | base station |
| 150 | core network(s) |
| 112, 113, 114 | radio links |
| 210-270 | phases of the process of FIG. 2A |
| 300-370 | structure of the device of FIG. 3 |
| 410-4920 | phases of signalling in FIG. 4 |
| 510-530 | phases of the method of FIG. 5 |

1. An apparatus comprising at least one processing core and at least one memory storing instructions that, when executed by the at least one processing core, cause the apparatus at least to:
be configured with dual connectivity wherein a first radio link is maintained from the apparatus to a master node, and simultaneously a second radio link is maintained from the apparatus to a cell of a secondary node;
participate in a reconfiguration of the configured dual connectivity wherein the cell of the secondary node is replaced in the configured dual connectivity with a new cell,
generate a cell change report which comprises reconfiguration information, and
indicate to the master node, responsive to successfully connecting with the new cell, that the cell change report is available in the apparatus.

2. The apparatus according to claim 1, wherein the apparatus is configured to perform the step of indicating at least in part by transmitting to the master node a message other than a radio resource control reconfiguration complete message, the transmitted message comprising an indication of availability of the cell change report.

3. The apparatus according to claim 1, wherein the apparatus is configured to perform the step of indicating at least in part by transmitting to the master node a user equipment assistance information message.

4. The apparatus according to claim 1, wherein in the dual connectivity the first radio link is based on a first radio access technology and the second radio link is based on a second radio access technology.

5. The apparatus according to claim 1, wherein the apparatus is configured to perform the indicating responsive to successfully connecting with the new cell by performing the indicating responsive to completing a random access process with the cell.

6. The apparatus according to claim 1, wherein the reconfiguration of the configured dual connectivity is triggered by the master node.

7. The apparatus according to claim 1, wherein the reconfiguration of the configured dual connectivity is triggered by the secondary node.

8. The apparatus according to claim 1, wherein the apparatus is configured to process a radio resource control reconfiguration message received in the apparatus from the master node, the radio resource control reconfiguration message comprising an indication that the apparatus should create the cell change report and indicate its availability to the master node after creating it.

9. The apparatus according to claim 8, wherein the apparatus is configured to process an instruction from the master node, identifying a message type the apparatus shall use in indicating the availability of the cell change report.

10. The apparatus according to claim 1, wherein the new cell is a primary secondary cell, PSCell, in the dual connectivity after the reconfiguration and the cell of the secondary node is the primary secondary cell, PSCell, in the dual connectivity before the reconfiguration of the dual connectivity.

11. An apparatus comprising at least one processing core and at least one memory storing instructions that, when executed by the at least one processing core, cause the apparatus at least to:
communicate as a master node in a configured dual connectivity with a user equipment wherein a first radio link is maintained from the apparatus to the user equipment, and simultaneously the apparatus controls a secondary node to maintain a second radio link with the user equipment;
participate in a reconfiguration of the configured dual connectivity wherein a cell of the secondary node is replaced in the configured dual connectivity with a new cell, and
receive, after receiving from the user equipment a radio resource control reconfiguration complete message and comprised in the reconfiguration of the dual connectivity, from the user equipment an indication that a cell change report is available in the user equipment.

12. The apparatus according to claim 11, wherein the apparatus is configured to provide to the user equipment a radio resource control reconfiguration message comprising an indication that the user equipment should create the cell change report and indicate its availability to the master node after creating it.

13. The apparatus according to claim 12, wherein the apparatus is configured to provide an instruction to the user equipment, identifying a message type the user equipment shall use in indicating the availability of the cell change report.

14. The apparatus according to claim 12, wherein the apparatus is configured to request, in the radio resource control reconfiguration message, that the user equipment indicates the availability of the cell change report after providing the radio resource control reconfiguration complete message to the apparatus.

15. A method comprising:
an apparatus being configured with dual connectivity wherein a first radio link is maintained from the apparatus to a master node, and simultaneously a second radio link is maintained from the apparatus to a cell of a secondary node;
participating in a reconfiguration of the configured dual connectivity wherein the cell of the secondary node is replaced in the configured dual connectivity with a new cell, and
generating a cell change report which comprises information on the reconfiguration, and indicating, responsive to successfully connecting with the new cell, to the master node that the cell change report is available in the apparatus.

16. The method according to claim 15, wherein the method comprises performing the step of indicating at least in part by transmitting to the master node a message other than a radio resource control reconfiguration complete message, the transmitted message comprising an indication of availability of the cell change report.

17. The method according to claim 15, wherein the method comprises performing the step of indicating at least in part by transmitting to the master node a user equipment assistance information message.

18. The method according to claim 15, wherein the reconfiguration of the configured dual connectivity is triggered by the master node.

19. The method according to claim 15, wherein the reconfiguration of the configured dual connectivity is triggered by the secondary node.

20. The method according to claim 15, wherein the method comprises processing a radio resource control reconfiguration message received in the apparatus from the master node, the radio resource control reconfiguration message comprising an indication that the apparatus should create the cell change report and indicate its availability to the master node after creating it.

21-27. (canceled)
